(19) United States
(12) Patent Application Publication
(10) Pub. No.: US 2016/0196517 A1
(43) Pub. Date: Jul. 7, 2016

(54) ENGINE, SYSTEM AND METHOD OF PROVIDING AUTOMATED RISK MITIGATION

(71) Applicants: Byron Burpulis, Rockland, DE (US); Josh Kelso, Rockland, DE (US)

(72) Inventors: Byron Burpulis, Rockland, DE (US); Josh Kelso, Rockland, DE (US)

(21) Appl. No.: 14/990,685

(22) Filed: Jan. 7, 2016

Related U.S. Application Data
(60) Provisional application No. 62/100,768, filed on Jan. 7, 2015.

(51) Int. Cl. G06Q 10/06

(52) U.S. Cl. CPC G06Q 10/0635

(57) ABSTRACT

The present invention provides an engine, system and method for providing normalized communications and data access between alternative platform systems and devices having access to the present invention. Such normalization may allow for the adaptation and development of applications and cloud-based services for interchangeable use between third parties client devices. The present invention may be immediately deployable within an existing technology infrastructure, and may be deployed as a thin client and/or user-transparent client, and may further provide for cross-platform communication between systems and devices not otherwise communicatively compatible.

### CROSS-REFERENCE TO RELATED APPLICATIONS

The present invention claims priority to U.S. Provisional Patent Application Ser. No. 62/100,768, filed Jan. 7, 2015, the contents of which are incorporated herein by reference in their entirety.

### FIELD OF THE INVENTION

The present invention relates to is a browser based online administrative risk mitigation tool utilized by enterprise clients, and, more particularly, to an engine, system and method of providing a more automated and efficient process and methodology for managing, monitoring, and maintaining online digital and mobile presence.

### BACKGROUND OF THE INVENTION

One of the main challenges facing most enterprise companies is that they support multiple public facing websites that require significant resources to maintain, monitor and manage. Through the normal course of business, enterprise websites undergo many instances of content and functional changes that require large investments of resources to implement and manage. As a result, many enterprise customer and public facing websites have inaccurate content and messaging displayed that poses potential risk to the organization. For example, risks may include: Financial (Tied to promotional offers and disclosures); Brand/Reputation; Customer Attrition; Partnerships/Vendor Attrition; Disruption in supply chain delivery of products/services; Internal and External Policy; and legal.

To date, there exists no single source software solution that allows an organization to ensure complete accuracy across all their online digital assets from a content and visual perspective. The present invention may provide enterprise clients an application that will automate monitoring of an online/digital asset (website, micro-site, mobile app) use multiple comparison methods alongside a rules-based interrogation engine to identify the differences from the intended display. Along with alleviating human error and enabling a more efficient and effective QA Testing process, the present invention may act as an audit tool to store and maintain versions of legal/risk/compliance digital communications.

Thus, there is a need for a single source solution that allows an organization to ensure complete accuracy across all their online digital assets from a content and visual perspective. More particularly, there is a need for an engine, system and method to provide enterprise clients an application that will automate monitoring of an online/digital asset (website, micro-site, mobile app) use multiple comparison methods alongside a rules-based interrogation engine to identify the differences from the intended display.

### SUMMARY

The present invention provides an engine, system and method for providing more automated and efficient process and methodology for managing, monitoring, and maintaining online digital and mobile presence. Such a system may allow for the elimination of human error and the enabling of a more efficient and effective system testing process. The present invention may also may act as an audit tool to store and maintain versions of legal/risk/compliance digital communications for use across the enable system. The present invention may be immediately deployable within an existing technology infrastructure, and may be deployed as a thin client and/or user-transparent client, and may further provide for cross-platform communication between systems and devices not otherwise communicatively compatible.

The present invention provides a system for auditing digital content, comprising a non-transitory computer readable medium having stored thereon a computer executable program, the computer executable program when executed causes a computer system to select a portion of a base digital content, wherein the base digital content comprises a static arrangement of information and is stored on a database communicatively coupled to the computer system; locate through at least one known address at least one presented digital content; compare the selected portion of the base digital content to a portion of the presented digital content; wherein the presented digital content is at least partially resident on at least one virtual server accessed by a remote user.

It is to be understood that both the foregoing general description and the following detailed description are exemplary and explanatory, and are intended to provide further explanation of the invention as discussed hereinthroughout.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods; and

FIGS. 3A-E illustrate exemplary embodiments of the present invention;

FIG. 4A-B illustrate exemplary embodiments of the present invention;

FIG. 5 illustrates an exemplary embodiment of the present invention;

FIG. 6 illustrates an exemplary embodiment of the present invention;

FIG. 7 is a block diagram of an exemplary computing system for use in accordance with herein described systems and methods;

FIG. 8 is a block diagram of an exemplary computing system for use in accordance with herein described systems and methods; and

FIG. 9 is a block diagram of an exemplary computing system for use in accordance with herein described systems and methods.

### DETAILED DESCRIPTION

A computer-implemented platform and methods of use are disclosed that provide more automated and efficient process and methodology for managing, monitoring, and maintaining online digital and mobile presence. Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

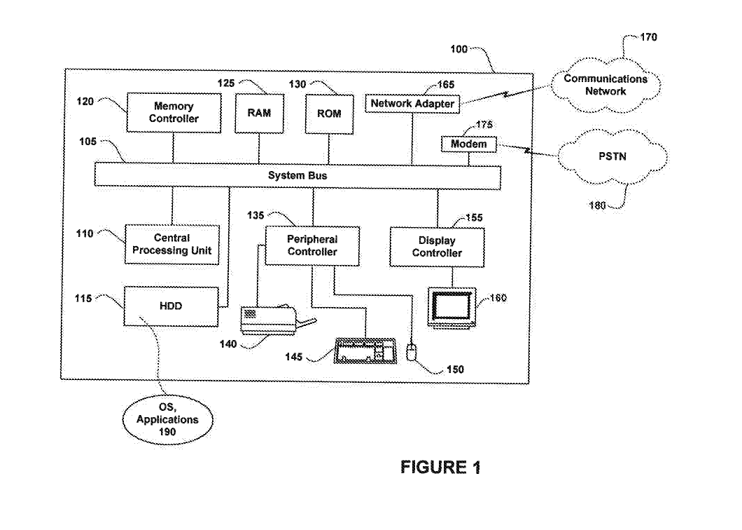

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

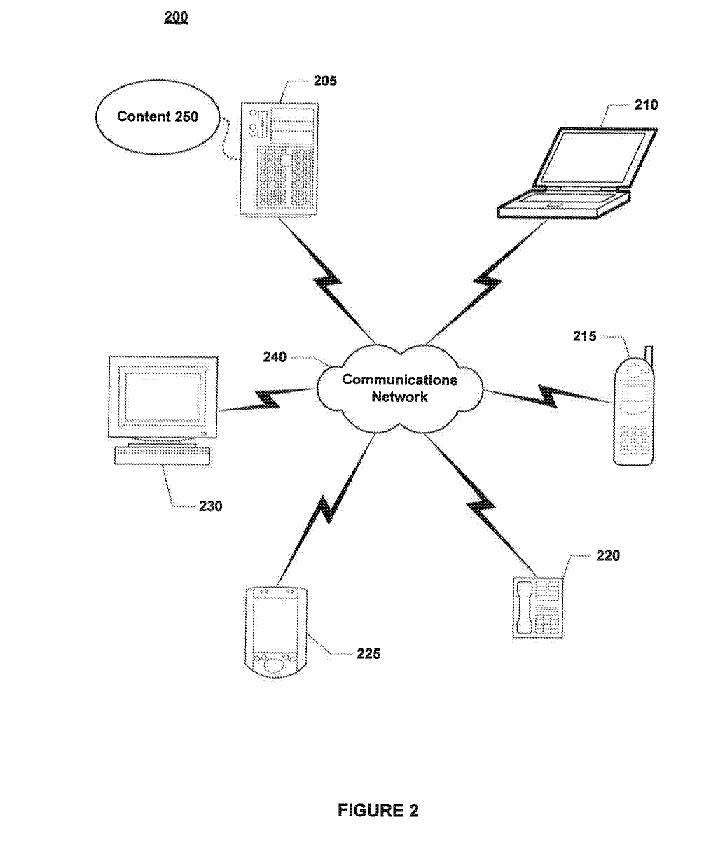

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

The present invention may provide functionality such as client Integration and absorption/Use by the client through a Web/Browser and with or without external and Internal hosting options (externally hosted—no internal tech development or installation needed by the client; internally hosted on clients enterprise hardware (environment); or a hybrid—by leveraging users's existing service integration provider.

The present invention may be configured in a number of ways, including: initial Setup of each URL to be monitored; records URL and auth credentials where required; user specific business rules; records user actions and keystrokes to replicate customer interaction; and/or utilizes those keystrokes to scan different browsers and versions selected by the user.

The present invention may provide for the recording of content using a recorder/snippet module and may provide the following functionality :Contextual comparison—HTML DOM (Document Object Model) layer; Pixel comparison—Image of each webpage or selected zone/area/snippet; Snippet comparison—Specific, user designated/identified section or area of a webpage; software will leverage contextual, pixel and snippet comparison functionality to identify any unintended display; Supports multi-browser functionality, to encapsulate entire customer population) a user may employ (any known browser system).

The present invention may provide various detection elements through at least one engine with may provide the use with: Delta in any visual and HTML elements; Variations in copy/text; Variation in asset and image location; Image accuracy; Validation of all internal and external links; and/or Validation of colors and style.

The present invention may provide a business rules engine which may provide: Rules based interrogational engine; Set business specific tolerances at multiple levels (for example, URL, Webpage, Snippet on a webpage (specific area identified on the webpage), Multiple snippets on a webpage, and/or Severity levels (high, med, low); Alert management through distribution list based on severity and/or Group setup and management (Production support=High, Business users=Low, etc) and include multiple channels of engagement for issue management (i.e., Email, Phone, and/or SMS).

The present invention may also provide scanning capabilities for: scanning desired URL(s) to, for example, determine the frequency of scans (multi-day, daily, weekly, monthly . . . etc.); and or scan, record and report/alert any and all variances that fall outside the set business rules and tolerances.

The present invention may also provide for QA/Testing, allowing for: automation of testing, such as regression testing, for example, which may reduce people hours to perform QA functions and/or reduces overall costs associated with regression testing; and improve systemic accuracy by removing human error from testing, lowering testing errors, and/or increasing management, controls and efficiency.

The present invention may also comprise at least one Back End Database for storing all data collected; collecting a history of each job/scan (such as errors found, overall status, and/or scan date/timestamp, for example); maintaining versions of selected jobs/scans to produce as audit trails; storing of current and previous status of all jobs/scans; storing results of each Job/Scan; storing user permissioning; and storing user actions (job setup, job initiation, etc).

As discussed herein, the present invention relates to a cloud-based and browser-accessed, on-line Software as a Service (SaaS) administrative interrogation engine to monitor and identify compliance, and perform as a risk mitigation tool to be utilized by enterprise clients. More particularly, to a rules based interrogation engine, system and method of providing a more automated and efficient process and methodology for managing, monitoring, and maintaining digital assets and environments, and the related and mobile presence.

An obstacle for content providers when communicating with various third party users and the various devices and software versions resident thereon, may be centered on the support of multiple public facing websites and other related digital assets, each of which may require significant resources to maintain, monitor, manage, and keep in compliance with regulatory regimes, other industry players, and, for example, Service Level Agreement (SLA) standards with State and Federal government regulatory bodies, industry committees and related standards organizations, Business to Business (B2B) client service contract standards, and end customer/consumer liability and serviceability warranties and obligations.

Through the normal course of business, enterprise websites may undergo many instances of content and functional changes that require large investments of resources to implement and manage. Such changes may include content as well as functionality changes, including, for example, altering the code used to fit and/or optimized use with various OS and access programs, such as browsers and the like. Such changes may result in inaccurate content and messaging being displayed that may pose potential risks to the organization and may compromise the exchange of information in and between highly regulated and secure environments.

The present invention may be used to service loyalty and rewards networks, existing customer marketing, new customer acquisition, and/or existing customer information dissemination through targeted B2B and B2C online and mobile digital lines of communication, marketing campaigns, and the like. In an embodiment of the present invention, a browser based, cloud-based, online, risk mitigation tool is provided which may be accessed and/or perform as SaaS, and allow for digital assets within web and digital development environments to be individually monitored and identified, maintained in compliance, assessed for currency and accuracy, split and Beta tested for effectiveness, archived, ticketed, organized, and repaired. The present invention may also provide overall risk management and mitigation in one automated and efficient tool for maintaining an organization's online digital environment, digital content development, and mobile presence.

In an embodiment of the present invention, a rules based interrogation engine may be implemented to detect alterations within a given digital view and compare and detect all inconsistencies across multiple complex digital environments that encompass infinite variables, which need to be kept within designated specification(s) or compliance, for example. This type of quality assurance with regard to the information and data provided to third parties may be an automated process to thus allow the monitoring and comparison aspects of digital assets and environments to be a quick and highly efficient process. Such a low lag time to presented content confirmation may greatly increase overall compliance with both internal controls and external rules and provide for an agile development processes, thus enhancing the expediency, accuracy, and efficiency of digital asset development and management from concept to completion and the ongoing refinement and redesign processes (website, micro-site, internet and intranet environments, mobile applications, digital content development) through the use of multiple overlapping and coordination of automated comparison methods.

In an embodiment of the present invention, the system may automatically interrogate and compare uniquely identify individualized graphics, single text characters for size and font, as well as word and character development treatments, customized selected groupings of content, text and graphic color variations and nuance by RGB hexadecimal value and pixilation configurations and concentration, as well as inconsistency and/or breakage in HTML and CSS and JavaScript and/or a webpage or destination Uniform Resource Locator (URL). Such interrogation may be performed by the present invention through a rules-based interrogation engine which may identify any number or combination of these selected elements within a web page, entire environment, or within a single identified digital asset, and estimate their deviation and/or difference from the intended display, and can compare the any alteration in a digital element with another, or whole and multiple complex website and/or digital environments.

In addition to the above-references quality assurance functionalities, in an embodiment of the present invention, the system may accumulate, in real time, data related to each instance of interrogation to identify changes and alterations, including where and when such changes occurred or were identified, which may increase the on-going intelligence and history record of what is required for the compliance for the digital asset(s) selected. Similarly, the system may store individual records of each iterative step in the on-going comparison/interrogation process, related to compliance, break fix, and refinement and redesign agile process and realization of a digital asset, or selected group of assets or entire web environment(s), so historical versions may be catalogued, reviewed, and used for various audit purposes, and/or repurposed from a library of key learning's for future system usage.

The present invention may also alleviate an organization's risk associated with financial promotional offers, disclosures, lapses and breaches in brand as well as reputation management issues through the real time monitoring and repair on non-conforming content and data. Such a result may decrease customer attrition caused to non functioning URL and/or poorly rendered or unreadable content, Partnership and Vendor Attrition due to Service Level Agreement (SLA) breaches and related penalties, Disruption of Supply Chain and Vendors, and inconsistencies in Legal disclaimer and related compliance parameters, and the inaccuracies and inconsistencies and liability of organizations utilizing partial or full manual process to perform these functions.

In an embodiment of the present invention, the system may provide the ability to identify and/or compare “snippets” or “selected zones”, in either specified digital asset, a portion of a digital asset, an entire digital page of content and/or image(s), and/or a single or multiple page(s) and/or web environment(s) as a contextual comparison in, for example, the HTML DOM (Document Object Model) Layer. Similarly, the system may interrogate “snippets” or “selected zones” as well for inconsistencies and to provide a validation of all internal and external links with an intended code baseline of CSS and JavaScript and/or a webpage or differences within the destination of Uniform Resource Locator (URL) line, and/or within a Pixel Comparison. The system may also be able to discern RGB hexadecimal value(s) and/or pixilation configurations and concentrations to functionality to identify any unintended display.

In an embodiment of the present invention, a business rule engine may be provided to provide a rules based interrogational engine that allows for the setting of specific tolerances within URL, webpage, “snippet” or “selected zones” on a Webpage related to a severity or sensitivity tolerance level (high, med, low). In conjunction with the setting of tolerance(s) in these areas, the system may link certain alert and management capabilities to the business rules engine to, for example, alert a distribution list of users based on the predetermined tolerance severity levels, as well as integrating the severity of alert into an organized group architecture. The system may provide specific channels of engagement for issue management through, for example, email, phone, and SMS, for accountability as well as for an audit trail of performance and resolution. As would be appreciated by those skilled in the art, a frequency of interrogations, for example, may be set by a user and may include periodic settings such as (multi-day, daily, weekly, and monthly, for example and may alert users to all or specific types of variances that fall outside the set business rules and tolerances.

As described herein, the present invention provides for the automation of quality assurance (QA) by automating specific QA checkpoints in the development of a digital asset and as a result, the amount of human labor required, because the quantitative intelligence of the present invention may continuously accumulate data related to all identified changes, alterations, and deletions as the digital asset(s) or ‘intended “snippet(s)” as they are continuously altered. As a record of development progress within any given digital asset(s) or intended “snippet(s)” is logged and archived, and the user may then be assured that only the most current version is being viewed. As system results are accumulated, the system may improve systemic accuracy, thus limiting and decreasing the effects of human error from testing, lessening errors and increases management controls and efficiency.

In an embodiment of the present invention, the system may be a digital marketing and compliance tool, comparison engine, an asset management, and risk mitigation tool, which may dissect and analyze digital assets from one piece of content or pixelization over a period of time or multiple pieces of content to determine what changes have been made to content (image, html, CSS, other programmatic code, and textual content) on an asset. The present invention may be used to analyze a website, mailer, or other digitally derived content.

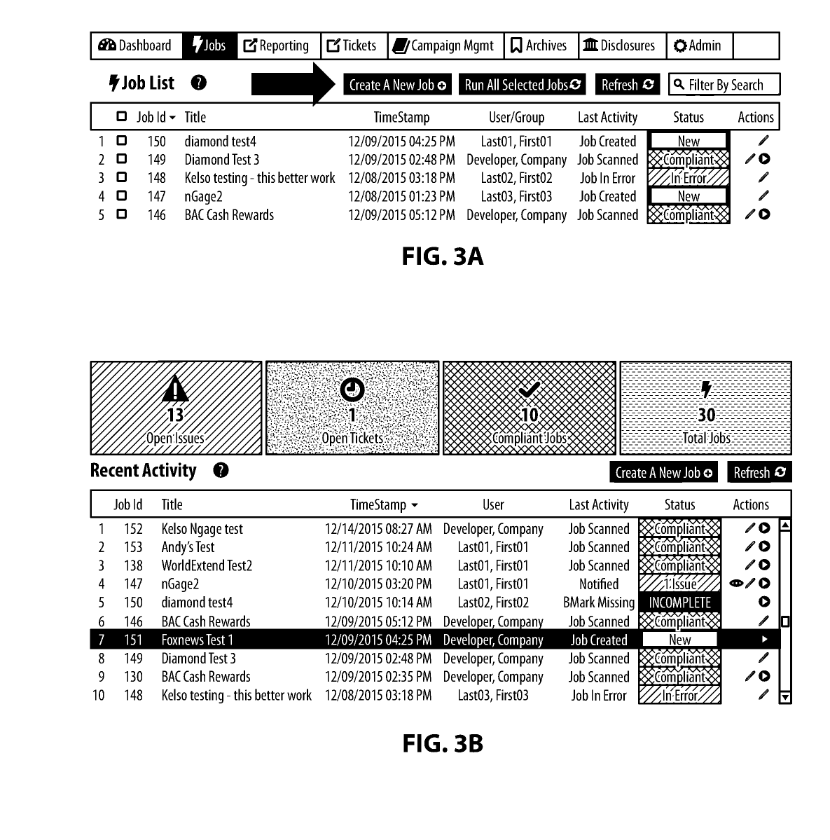

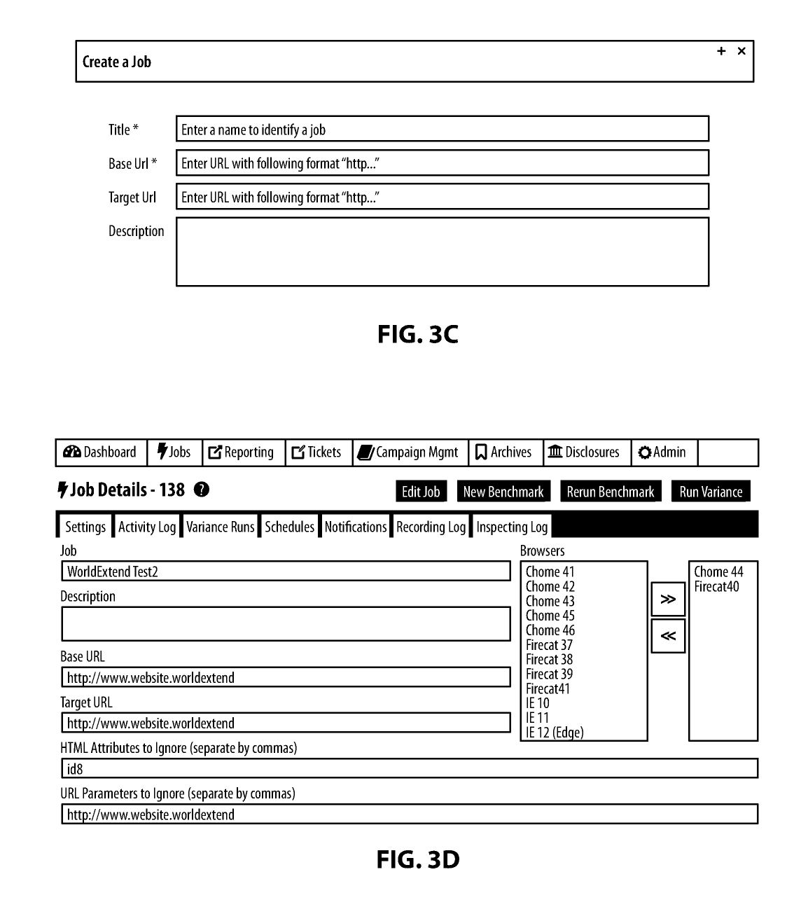

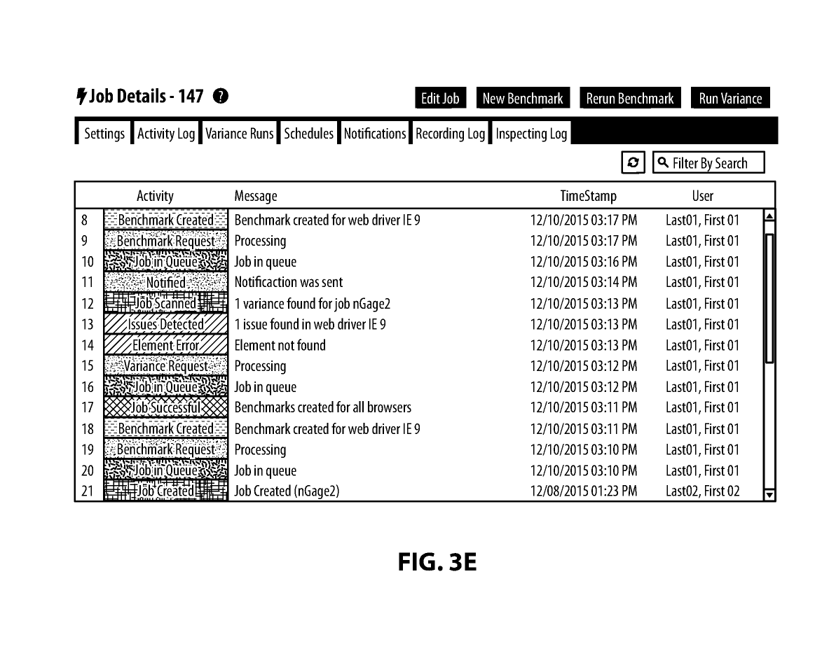

As illustrated in FIGS. 3A and 3B, the system of the present invention may provide a product that allows for the creation and auditing of jobs which may be executable tasks designed to interrogate and compare certain media targets in accordance with the present invention. As illustrated in FIG. 3A, the user interface associated with the present invention may allow for the creation of a new job, execution of existing jobs, reporting of job status and outcomes, and the reporting of any system issues and or follow-up need by the user in the form of a ticket issued related to a job. The system may also provide functionality related to the control of multiple jobs through a campaign manager and may also allow for easy access to historical use records, records which may also be used by the QA portions of the present invention to track effectiveness. The system may allow for each job to be titled and may provide a status update to alert a user to whether, for example, the job is new, is complaint (at least from its last run) and/or whether an error has occurred.

As illustrated in FIG. 3B, in addition to much of the functionality described above, job records may be more easily navigated to allow a user to select a recent job. As illustrated, the present invention may also provide highly visible alters/status updates to make the user aware in real-time of any issues, for example, which may occur when a plurality of jobs is running in a given period of time. As discussed herein, jobs may be run at a predetermined time and/or over a predetermined interval. Jobs may also be queued to run when certain benchmarks are met, such as, for example, the number of visitors to a particular URL has been reach, or the number of click-through for a particular link has been exceed. Although many iterations of benchmarks may be used, third-party user interaction with a piece of content may be used as a trigger for job execution and may be used in conjunction with other metrics, such as the time boundaries discussed above.

As illustrated in FIG. 3C, a job to be created may include an identifier, a free-form description portion, and both a base URL and Target URL addressing space, for example, when a job is meant to be limited to the interrogation and comparison of two web pages. Once created, the present invention may present to the user an image of either the base URL and/or the target URL, for example, to confirm for the user that the addresses provided were pointed to the desired webpage. Once the user has created a job, the present invention may provide an interface as illustrated in FIGS. 3D and 3E, for example. FIG. 3D illustrates a job details page having at least one activity log comprising various messages and statuses for at least one particular job. A user may be notified, for example, if a job benchmark has been created, if a job is in queue, if an executed job was successful, if there is a variance request, if there was an issue detected, if a scan has been completed, and/or if a user has been notified of any of one or more of the aforementioned activities. Such a details page may provide the user with easy and complete access to substantially all information related to a particular job. Information related to the type of browsers that are anticipated to be encountered, for example, may be listed and/or selected. In this way, a particular job may be optimized towards a specific group our users if, for example, the target URLs are assumed to exists only on iOS devices.

As illustrated in FIG. 3E, additional details may be provided by the present invention and may include an activity log with all of the various messages and statuses for a job. Such a log, as illustrated, may allow for more real time analysis of the activity associated with a job and may allow a user of the present invention to confirm that the expected tasks are being completed in the desired manner.

As discussed above, if a job is constructed to analyze particular content, execution of that job may result in the recordation of a job record related to the interrogation and/or comparison throughout a piece of content. As a non-limiting example only, a user may select an area on a web page to monitor (text, images, buttons, headers, footers, etc.). From this single or multi-select user transaction, a user may set a digital asset baseline. From such a baseline, the user may then execute individual jobs. As an example, a comparison-based job may craw a target asset and compare selected areas from the baseline with the same areas on the target page(s). Each variance is then logged to the database and further analysis is completed to determine the root cause of the variance. Users may be alerted via the system provided GUI or via email, for example. The system may also have the capability to also alert users via SNMP if needed.

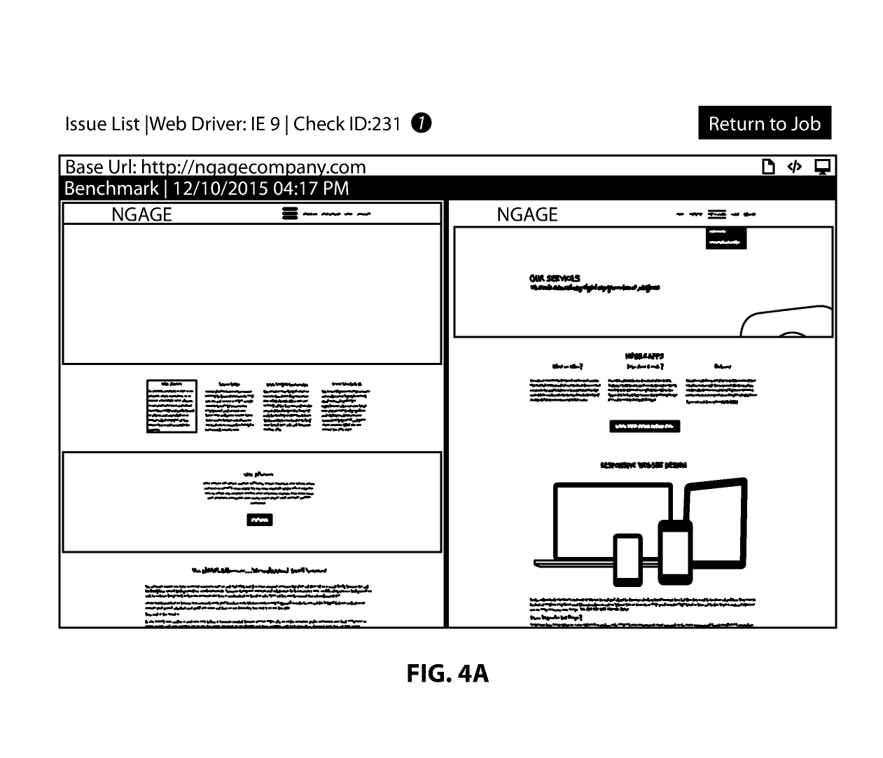

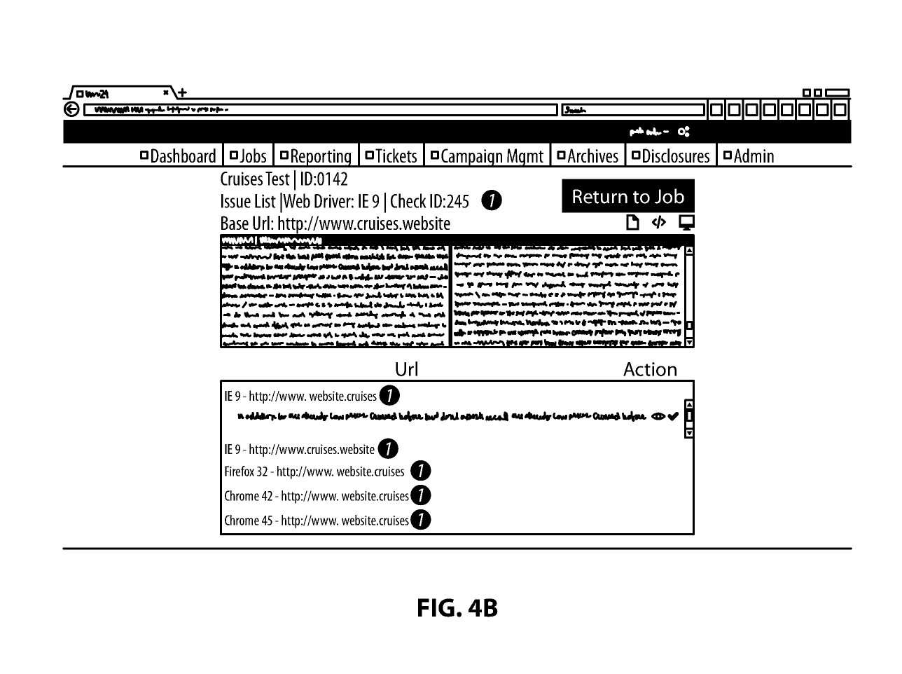

A user may also be provided the ability to see a side by side visual comparison of the baseline and target pages, for example, as illustrated in FIG. 4A. A variant area may be highlighted on either side of the visual comparison screen. A user may also be presented with details of the issues that were found with the asset(s). Users may also time delay or calendar such a change in status to allow them to follow up at another time (or have someone else follow up for them) or a user may change the status of the issue to “Resolved” if warranted. As illustrated by FIGS. 4A and 4B, the present invention may allow a user to compare a full website over time or immediately with another site (production, staging, UAT, development) and/or any component of any website. The present invention may provide a user the ability to compare pixels in one image to another image, even if the size, name, and description of the image are exactly the same. The present invention may be able to determine variances from pixel to pixel or across an entire image.

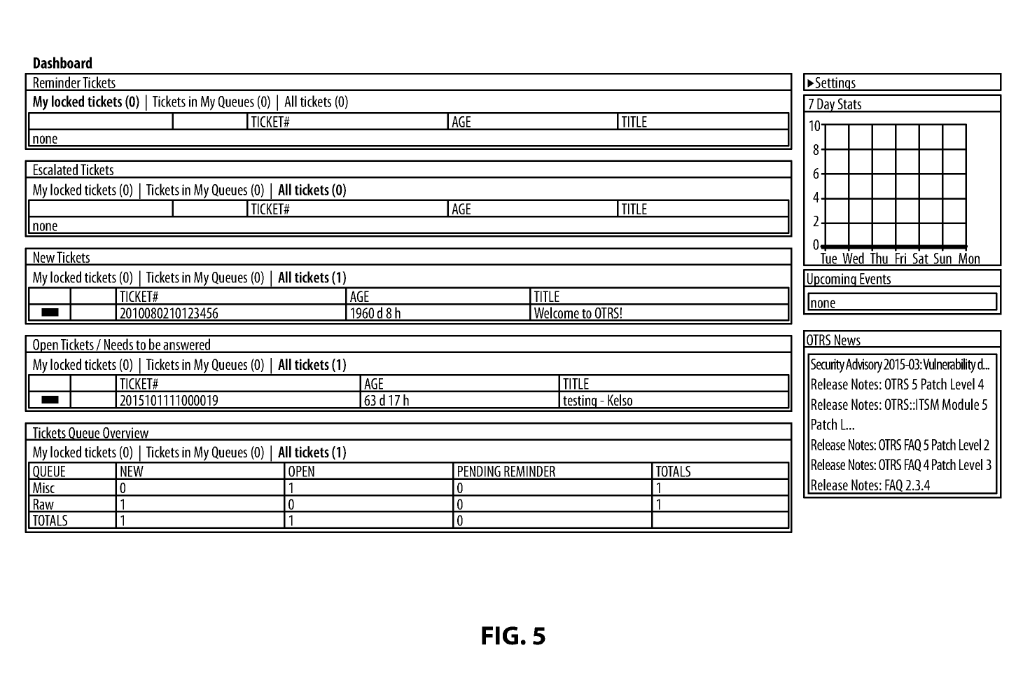

In an embodiment of the present invention, the system is accessed through at least one application plug-in installed in at least one third-party system. Once the plug-in is installed, the user may be presented with a dashboard, as illustrated in FIG. 5, which may display summary information on issues, open tickets, compliant jobs, and total jobs that have been completed. Additionally, in the dashboard, there may be a display summarizing recent scan activity, job status, and actions that need to be taken (if necessary), among access to the other functionality discussed herein. The dashboard may also provide information related to open tickets related to issues found as between interrogated content, for example, a running time delineated stats counter, calendar features, settings menu and a list of reminders and/or news associated with the content.

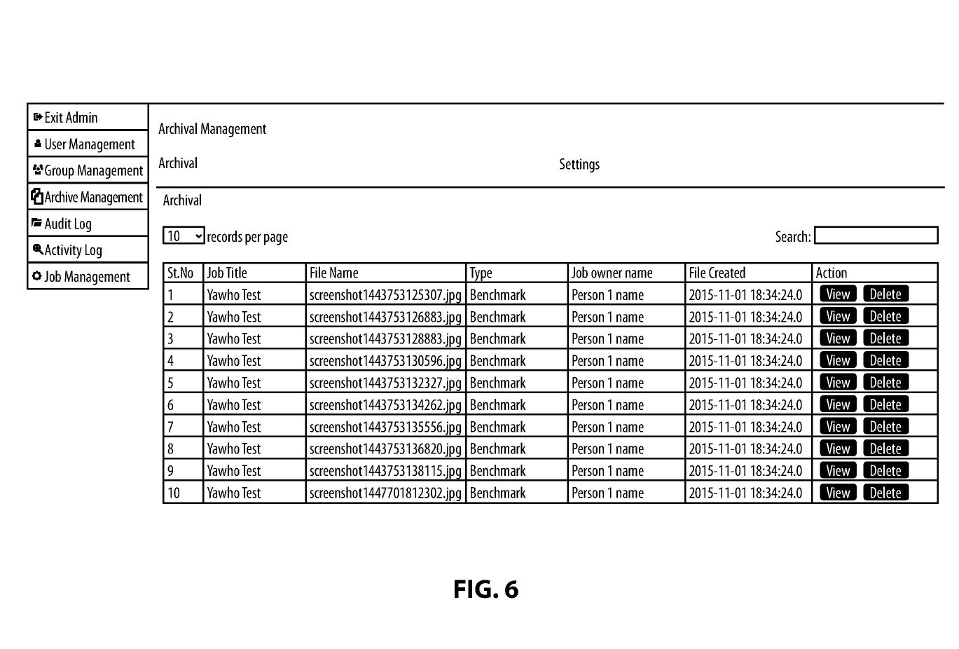

As illustrated in FIG. 6, an archival management subsystem may be used to ensures that a job, its benchmark, its associated content, imagery, and the like is captured and stored on its retention, such as in a WORM format, for example. The present invention may also include at least one disclosure portlet which may allow a customer to compare a job against the required disclosures needed for a company. For example, banks and pharmaceutical companies, to name just two types of heavily regulated industries, have strict requirements on what disclosures are necessary and may be exposed to great damage if such disclosures are not correct. The present invention allows a user to check the organizational specific disclosures that are needed and determine if a comparison site has those disclosures present. If the disclosures are not present, an error and ticket may be generated.

Use of the system provides administrative functionality which may allow users and administrators to add users to the system, add users to security or email groups as needed, while auditing authentication and authorization rules which may accompany use of the system by any user. The present invention may also interface successfully with authentication and authorization systems located remote from the system which may be capable of hooking into the authentication/authorization components already implemented by a system user.

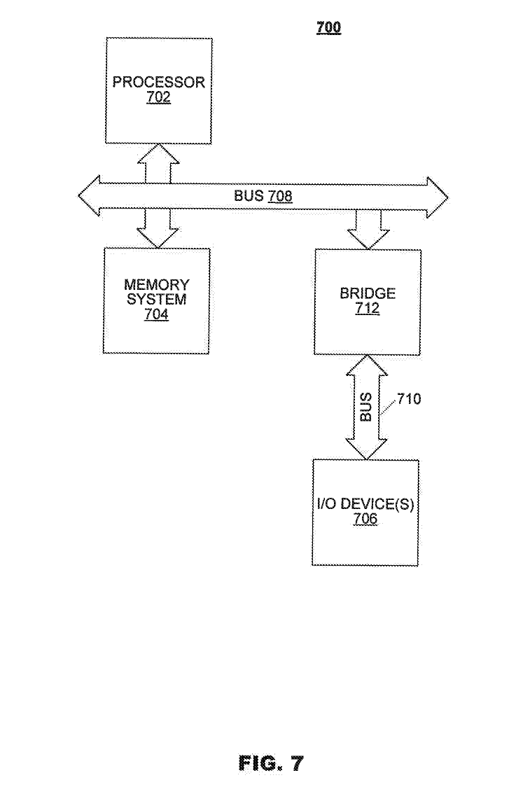

FIG. 7 is an example of a simplified functional block diagram of a computer system 700. The functional descriptions of the present invention can be implemented in hardware, software or some combination thereof. For example, a recommendation engine and an integration engine of the present invention can be implemented using a computer system.

As shown in FIG. 7, the computer system 700 includes a processor 702, a memory system 704 and one or more input/output (I/O) devices 706 in communication by a communication ‘fabric’. The communication fabric can be implemented in a variety of ways and may include one or more computer buses 708, 710 and/or bridge and/or router devices 712 as shown in FIG. 7. The I/O devices 706 can include network adapters and/or mass storage devices from which the computer system 700 can send and receive data for generating and transmitting advertisements with endorsements and associated news. The computer system 700 may be in communication with the Internet via the I/O devices 708.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

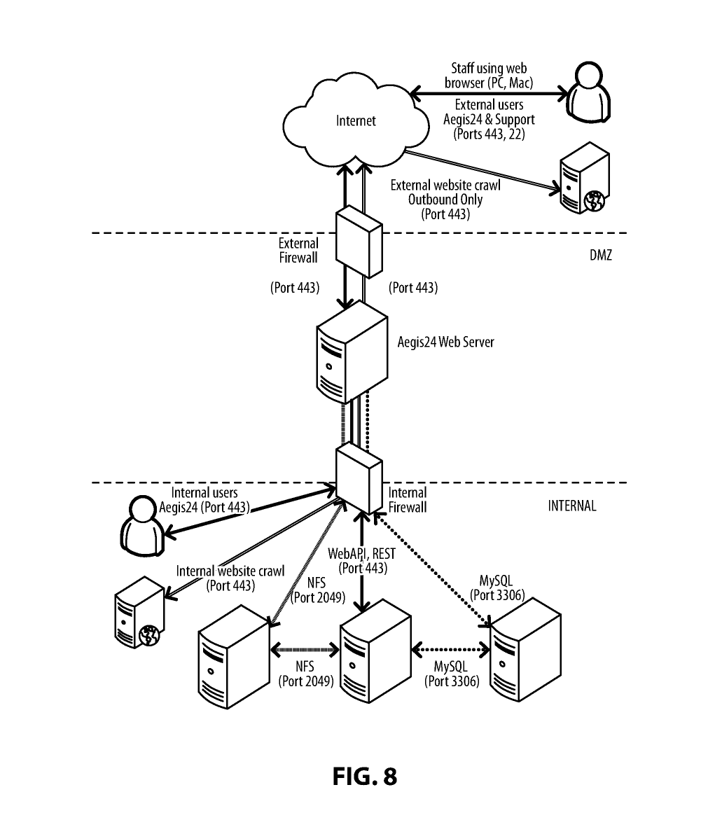

In an embodiment of the present invention, the system may include a network architecture as illustrated in FIG. 8, which may include a multiple server system across at least one dynamic network. System access by a user may first occur remotely using a VPN or SSL VPN, for example, into a targeted work environment. Access into the work environment will allow a user access to the system web server, which may house the front-end application and dashboard, as discussed above. Within the front-end application server, a user may create a job, access their currently run jobs or their team's jobs, submit a ticket, access past disclosure or archival information, or gain access to reports. Behind the system web server environment may reside a backend infrastructure which may include a firewall environment that may allow the web server to commnunicate to the associated back-end systems. All server transactions, especially those passing through a firewall, may be encrypted using SSL, for example.

Front-end system programs may include programs used to display the user interface (UI) web pages to the user, for example. In addition to libraries provided by Java frameworks, the primary third party UI framework utilized may be handled via an AJAX web application development framework that enables developers to build high-quality user interfaces with Java, both on the server- and client-side. Such a system may provide a set of libraries of ready-to-use user interface components and a clean framework for creating your own components. The focus is on ease of-use, re-usability, extensibility, and meeting the requirements of large enterprise applications. As discussed above, the system may utilize a plug-in that may support the user process of recording the navigation commands and the selection commands of specific website content.

The backend of the system may be responsible for processing benchmark and variance functions of the system. Both functions may take commands from the system plug-in level and send them to a server to perform the commands using a designated web driver. The system may avoid using. a dynamic, virtual server platform to handle concurrent application sessions by utilizing a browser stack remotely hosted from the system. Such a backend may allow for more easily accessible memory and computing environment expansion.

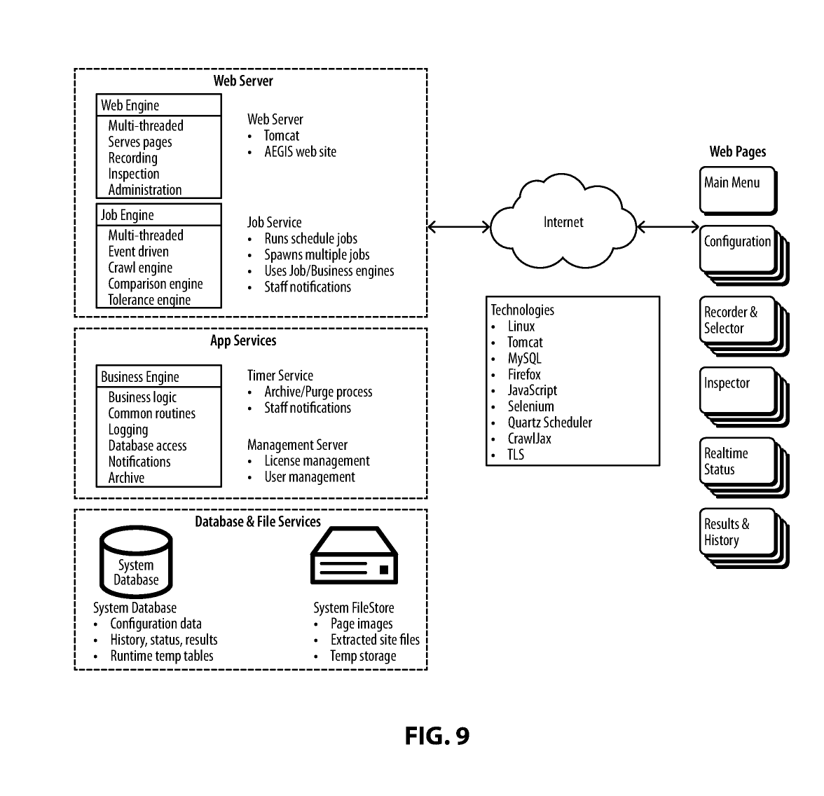

As illustrated in FIG. 9, the system web server may house at least two engines, a web engine and a job engine. The web engine may be multi-threaded and allow for multiple jobs to be run simultaneously without impacting the performance of other jobs that are already being processed. The web engine may also be responsible for web recording, digital media inspection, and general administration and management. The job engine may be event driven and may be used to crawl various sites and to compare those same sites to at least one base site. The job engine may also have a tolerance engine built into the system and allow a user to run scheduled jobs, spawn multiple jobs, leverage the business engines, and provide staff notifications.

In an embodiment of the present invention, a receiver of medical information may be provided with a normalized presentation of information to ensure the complete delivery and viewability of such information. For example, when purchasing medical devices and/or prescription drugs, some information may be provided to the recipient of such goods via electronic delivery, such as, for example, an email, web portal, and/or app GUI. Although the medical provider may exert some control over the delivery of the information and/or the GUI used by the recipient, such control does not always exists and may not be guaranteed or sufficiently verified to satisfy the needs of the provider, such as regulatory requirements, for example.

An illustrative example includes the provision of medical use information to a receiver of prescription drugs. For example, a Medicare insured person may go to a local pharmacy and present a prescription for a certain prescription drug. Although the prescription drug may include regulatory mandated information on the label of the dug container and/or on additional labeling printed by the pharmacy, the drug provider and/or the pharmacy may wish to send additional information to the recipient electronically as described above. In this example, the receiver of the additional information has agreed to visit a website whose address is provided on some aspect of the provided labeling and does so to view additional information related to prescription drug. However, the server accessed by the recipient through the provided web address is only capable of providing properly formatted information to versions of a browser newer than the browser used by the recipient. Thus, the older browser may not display the information as intended. For example, the information may not be formatted as intended nor may it be fully displayed (such as being “shown” off screen or out of the viewable area). More generally, the information and possibly embedded action buttons or links, may not be displayed or provided in a way which will allow them to be functionally useful to the intended recipient, resulting in a failure to provide or certify that certain information was provided to the intended recipient.

In an embodiment of the present invention, the present invention may identify and recognize the browser version, as well as device type, connection spped, location, and other attributes known to those skilled in the art, as used by the accessing drug recipient and may provide an information access point suitable to provide the above referenced information in a substantially suitable format as to comply with any regulatory and/or other rule or regulation regarding the providing of information to a recipient. As described herein, the present invention may detect the use of an older version internet browser and may direct the incoming access request to one of a plurality of virtual servers compatible with the accessing browser version. By way of non-limiting example only, accessing a provider's website with version 0.2.149 of Google Chrome requires different formatting and technical capabilities that accessing with 47.0.2526.106 m of Google Chrome.

The present invention may also provide reporting features providing to a user: overall page level variance report; contextual variance report; pixel variance report; and/or a snippet variance report. Templated Reports may be used to provide users the ability to create reports with existing tracked data to provide differentiated levels of reporting. Both detail and summary level data will be supported. Customized reports may also be created and include a drag and drop interface to create unique reporting based on existing data. Frequency, distribution list and data would be defined for each report to meet business user and executive level needs. Reports may also provide historical information and enable tracking and reporting of issue management and remediation and/or tracking of issue remediation timeframe and SLA adherence. Reports may also allow for “versioning” and the maintenance of historical versions of selected assets over specified timeframes and/or the ability to ‘tag’ specific areas/assets/snippets/pages/content areas to maintain historical versions for auditing purposes.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A system for auditing digital content, comprising:
a non-transitory computer readable medium having stored thereon a computer executable program, the computer executable program when executed causes a computer system to:
select a portion of a base digital content, wherein the base digital content comprises a static arrangement of information and is stored on a database communicatively coupled to the computer system;
locate through at least one known address at least one presented digital content;
compare the selected portion of the base digital content to a portion of the presented digital content;
wherein the presented digital content is at least partially resident on at least one virtual server accessed by a remote user.
